(19) United States
(12) Patent Application Publication
(10) Pub. No.: US 2007/0053117 A1
(43) Pub. Date: Mar. 8, 2007

(54) Ballast reset switch

(76) Inventor: Terry Ray Harter, New Palestine, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/220,314

(22) Filed: Sep. 6, 2005

(51) Int. Cl. H02H 9/08

(52) U.S. Cl. 361/42

(57) ABSTRACT

A lamp fixture assembly is provided that includes a lamp fixture, a ballast having a power input, and a reset switch operatively connected between the power input of the ballast and a power source. The reset switch is disposed in relation to the lamp fixture such that the reset switch is activated to cycle power to the ballast by removal of a lamp from and insertion of a lamp into the lamp fixture.

### FIELD OF THE INVENTION

The invention relates to a lamp fixture assembly and, more particularly, to a lamp fixture assembly that has a lamp fixture, ballast with power input, and a reset switch that resets power to the ballast when activated.

### BACKGROUND OF THE INVENTION

Conventional HID lamp fixture assemblies such as metal halide lighting assemblies, incorporate HID electronic ballasts. The HID electronic ballasts typically turn off power to the lamp when an abnormal operating condition is detected, such as a defective lamp, to avoid high voltage arcing during re-lamping that may cause damage to ballasts and other circuit components and present safety concerns. Thus, due to high voltage damage and safety concerns, an HID electronic ballast that has detected an abnormal condition requires input power to the ballast needs to be shut off for at least a pre-determined period of time and then turned back on (i.e. cycled) before the HID electronic ballasts will re-strike or provide power to a lamp in the fixture. For conventional HID lamp fixture assemblies, input power to an HID electronic ballast is typically reset by cycling the circuit breaker switch for the branch circuit from which the HID lamp fixture assembly, with the respective HID electronic ballast, receives input power. However, as a result, all the fixtures on that branch circuit are turned off, even if only one lamp in one fixture on that branch circuit has failed, causing undue wear on ballasts in other fixtures and creating a dangerous condition of substantially reduced light level or total light elimination for replacing the failed lamp. In addition, re-striking of HID lamps often can take a period of time (10-15 minutes), which increases safety concern of reduced or total light elimination in commercial or retail lighting applications.

One conventional HID lamp fixture assembly shown in FIG. 1 has a lamp fixture 12 and an electronic ballast 14 that receives input power from a branch circuit power line 16 via a manual reset switch 18. The ballast 14 is associated with a terminal or junction box 20, which is disposed away from the lamp fixture 12 in accordance with customary lighting industry practices so that installation of the lamp fixture assembly 10 conforms to local electrical codes. The manual reset switch 18 is typically mounted on the junction box 20 to be in proximity of input power to the ballast 14. As a result, the manual reset switch 18 is inconveniently located away from the lighting fixture 12 in the conventional HID lamp fixture assembly 10, making the process of re-lamping the HID lamp fixture assembly 10 unnecessarily difficult. Moreover, when the conventional HID lamp fixture assembly 10 is recessed into a ceiling 22 as shown in FIG. 1, the junction box 20 with the ballast 14 and the manual reset switch 18 are typically enclosed above the ceiling 22 making the process of re-lamping the HID lamp fixture assembly 10 more difficult and may lead to damaging a portion of the ceiling 22 (e.g., a ceiling tile or track). Some conventional lamp fixture assemblies that incorporate quartz-jacketed or other high-UV metal halide lamps have a lens door with an interlock switch that turns power off to the fixture when the lens door is opened to ensure that current does not continue to flow to the lampholder during re-lamping or lens cleaning. Particularly, where only the lens is being cleaned, it is undesirable for the lampholder to be de-energized. HID lamp fixture assemblies typically do not allow for the use of a lens door because the lens door increases thermal levels within the lamp fixture assembly causing potentially dangerous conditions.

Therefore, a need exists for a lamp ballast power reset switch that overcomes the problems noted above and others previously experienced for re-lamping an HID lamp fixture. These and other needs will become apparent to those of skill in the art after readying the present specification.

### SUMMARY OF THE INVENTION

The foregoing problems are solved and a technical advance is achieved by the present invention. Disclosed is a lamp fixture assembly comprised of a lamp fixture, an electronic ballast with a power input and a reset switch. The reset switch is disposed in relation to the lamp fixture such that the reset switch is activated to cycle power to the ballast by removal of a lamp from and insertion of a lamp into the lamp fixture. In one embodiment, the reset switch has an actuator such that when a lamp is inserted into the lamp fixture the actuator is engaged.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a conventional lamp fixture assembly incorporating a manual ballast reset switch;

FIG. 2 depicts one exemplary lamp fixture assembly having an electronic ballast and a reset switch to automatically reset power to the ballast in accordance with the present invention;

FIG. 3 is block diagram depicting an exemplary power distribution system in which a branch circuit employs a plurality of lighting assemblies each having an electronic ballast and a reset switch to automatically reset power to the ballast in accordance with the present invention;

FIG. 4A depicts an exemplary switch that may be employed in a lamp fixture assembly in accordance with the present invention, where the switch has an actuator shown in an engaged position;

FIG. 4B depicts the switch in FIG. 4A, where the actuator is shown in a disengaged position;

FIG. 5A depicts another exemplary switch that may be employed in a lamp fixture assembly in accordance with the present invention, where the switch has an actuator shown in an engaged position;

FIG. 5B depicts the switch in FIG. 5A, where the actuator is shown in a disengaged position;

FIG. 6 depicts another exemplary lamp fixture assembly having an electronic ballast, a sensor to detect the installation or the removal of a lamp in the lamp fixture assembly, and a reset switch to automatically reset power to the ballast based on the detected installation or removal of the lamp;

FIG. 7 depicts another exemplary lamp fixture assembly having an electronic ballast, a sensor to detect the installation or the removal of a lamp in the lamp fixture assembly, and a reset switch to automatically reset power to the ballast based on the detected installation or removal of the lamp; and

FIG. 8 depicts another exemplary lamp fixture assembly having an electronic ballast, a sensor to detect the installation or the removal of a lamp in the lamp fixture assembly, and a reset switch to automatically reset power to the ballast based on the detected installation or removal of the lamp.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts. As would be understood to one of ordinary skill in the art, certain components or elements for an electrical device (e.g., ground line connections, or power return lines) are not shown in the figures to avoid obscuring the invention.

A lamp fixture assembly consistent with the present invention simplifies the re-lamping process by allowing power to an electronic ballast associated with the lamp fixture to be reset automatically based on the insertion or removal of a lamp into the lamp fixture. FIG. 2 depicts one exemplary HID lamp fixture assembly 100 including a lamp fixture 102, an electronic ballast 104 having a power input 110 and a reset switch 106 operatively connected between the power input 110 of the ballast 104 and a power source, such as a branch circuit line 112. The lamp fixture 102 may be a recessed light fixture, a tracking lighting fixture, or any other lighting fixture. The electronic ballast 104 may be a metal halide ballast or other ballast used to convert a standard line voltage (e.g., 120 V) to a high intensity discharge voltage (e.g., 277V) for powering a lamp 50.

The reset switch 106 is disposed in relation to the lamp fixture 102 such that the reset switch 106 is activated to disconnect power to the electronic ballast 104 for at least a predetermined time by removal or insertion of a lamp 50 into the lamp fixture 102, and more particularly lampholder 114. The predetermined time may be a fraction of a second or sufficient time for the electronic ballast 104 to discern that power on input 110 has been cycled off and on. In one implementation, the predetermined time is the period of time required by the electronic ballast 104 to clear any latched lamp anomaly condition. In one embodiment, the switch 106 has an actuator 108, such as an arm or toggle lever, disposed in relation to the lamp fixture 102 such that the lamp 50 during insertion into the lamp fixture 102 engages the actuator 108 to activate the switch 106 and reset power to the ballast 104. The actuator 108 is further operatively configured to deactivate the switch 106 when the actuator 108 is disengaged from the lamp 50.

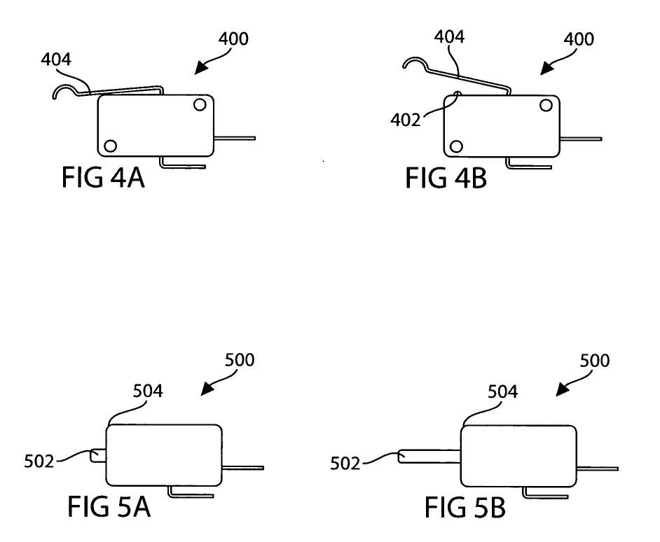

In the implementation shown in FIG. 2, the lamp fixture 102 has a lampholder or socket 114 and the actuator 108 is disposed in relation to the socket 114. For example, the actuator 108 may be disposed a predetermined distance (d) away from the socket 114. The predetermined distance (d) may be derived based on the contour and size of a predetermined type of the lamps 50 that the lamp fixture 102 was designed to accept or that are approved for use in the lamp fixture by Underwriters Laboratories (UL) or other regulatory agency. In one implementation, the predetermined distance is set so that the lamp engages the actuator 108 as the lamp 50 is being set into the socket 114. In this implementation, the actuator 108 is operatively configured to activate the switch 106 when the actuator 108 is moved to a first or fully engaged position (see FIG. 4A or 5A) by the insertion of the lamp 50 into the lamp fixture 102. The actuator 108 is operatively configured to deactivate the switch 106 when the actuator 108 is moved to a second position by the removal of the lamp from the lamp fixture (see FIG. 4B or 5B). As discussed below, the switch 106 may have an internal spring or other bias means for moving the actuator to the second position when a lamp 50 is removed from the socket 114. In this manner, the reset of the electronic ballast necessarily occurs when the lamp is replaced.

The lamp fixture 102 may also include a housing 116 in which the lampholder 114 is mounted. The lamp fixture 102 may further include one or more support members 118 and 120, such as a can or bracket, for mounting the socket 114 and for mounting the switch 106 relative to the socket 114.

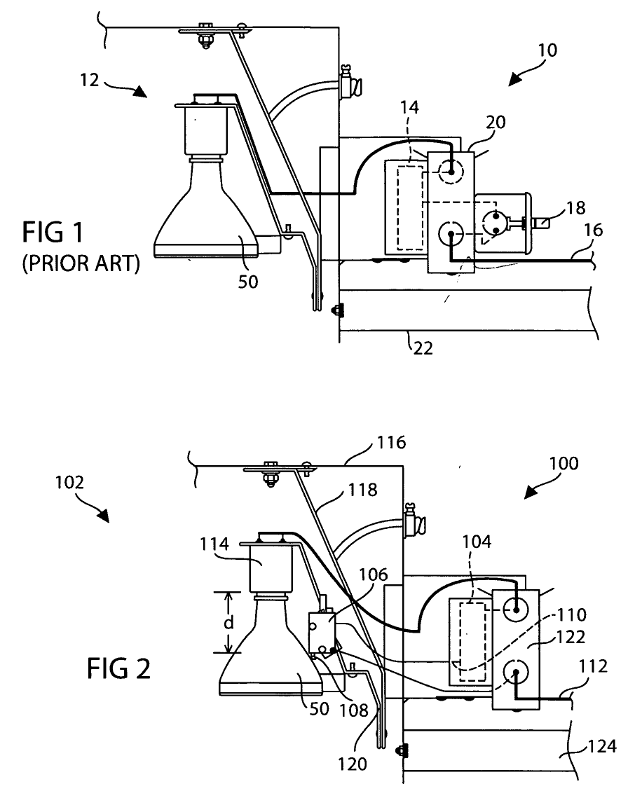

In one implementation, the lamp fixture assembly 100 includes a junction box 122 to house the ballast 104. The junction box 122 with the ballast 104 may be disposed away from the lamp fixture 102 and enclosed above a ceiling tile 124 without impacting the operation of the switch 106 in accordance with the present invention. Thus, unlike the conventional embodiment shown in FIG. 1, there is no need to remove or otherwise damage the ceiling tile 124 to reset the ballast 104.

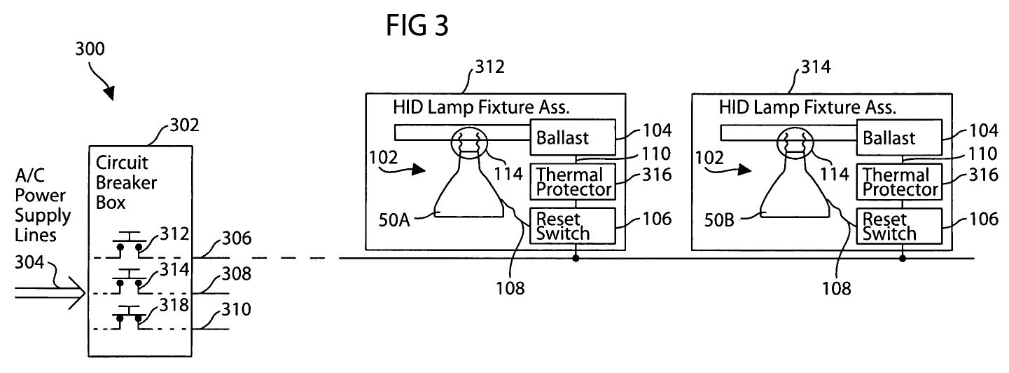

When a lamp fixture assembly 100 consistent with the present invention is employed in a branch circuit that provides power to other lamp fixture assemblies, the lamp fixture assembly 100 may be re-lamped without removing power to the other lamp fixture assemblies, and hence without turning off power to an entire branch circuit. For example, FIG. 3 depicts a block diagram of an exemplary power distribution system 300 having a circuit breaker box 302 that distributes input power from A/C power supply lines 304 to multiple branch circuit lines 306, 308, and 310. Each branch circuit 306, 308, and 310 may provide input power to a respective group of lamp fixtures 312 and 314 in one or more rooms of a commercial or residential building. The circuit breaker box 302 has a circuit breaker switch 312, 314, and 318 operatively connected to activate or deactivate the distribution of power to a respective branch circuit line 306, 308, or 310. For an understanding of the present invention, lamp fixtures on branch circuits 308 and 310 need not be shown.

In the implementation shown in FIG. 3, each lamp fixture assembly 312 and 314 includes a lamp fixture 102, a ballast 104 having a power input 110 and a reset switch 106 operatively connected between the power input 110 of the ballast 104 and the branch circuit line 306. However, the lamp fixture assembly 312 and 314 need not be identical in size, shape, or components. For example, lamp fixture assembly 312 may have a different ballast 104 and different switch 106 than the lamp fixture assembly 314 to support different types of lamps 50A and 50B. As shown in FIG. 3, each lamp fixture assembly 312 and 314 may have a thermal protector 316 operatively connected between the power input 110 of the ballast 104 and the reset switch 106. Each thermal protector 316 is operatively configured to turn power off to the ballast 104 of the respective lamp fixture assembly 312 or 314 when a thermal level (e.g., a temperature within the lamp fixture 102) sensed by the thermal protector 316 exceeds a predetermined level. In an alternative implementation, the reset switch 106 may be disposed between the input power of the ballast 104 and the thermal protector 316 of the lamp fixture assembly 312 or 314. As shown in FIG. 3, the removal of the lamp 50A causes the lamp 50A to be disengaged from the actuator 108 of the reset switch 106 in the lamp fixture assembly 312 automatically causing the switch 106 to deactivate and remove power from the power input 110 of the corresponding ballast 104 without causing power to be removed from another lamp fixture assembly 314 on the same branch circuit line 306. Similarly, inserting a new lamp 50A into the socket 114 of the lamp fixture assembly 312 causes the new lamp 50A to engage the actuator 108 to activate and reset power to the corresponding ballast 104 without disrupting power to other fixtures 314 receiving power from the same branch circuit line 306.

FIGS. 4A and 4B depict an exemplary switch 400 that may be employed in a lamp fixture assembly 100, 312 or 314 in accordance with the present invention. The switch 400 includes a plunger 402 and a lever arm 404 disposed relative to the plunger 402 and relative to the lamp fixture 102 when employed in the assembly 100, 312, or 314. When the lamp 50 is inserted into the lamp fixture 102, the lever arm 404 engages the lamp 50 which then moves the lever arm 404 to engage the plunger 402, activating the switch 400. FIG. 4A depicts the switch 400 after the lamp 50 has moved the lever arm 404 to a first position to engage the plunger 402 (not in view in FIG. 4A).

When the lamp 50 is removed from the lamp fixture 102, the lever arm 404 is biased to move away from or disengage the plunger 402 to deactivate the switch 106. FIG. 4B depicts the switch 400 after the lamp 50 has been removed and the lever arm is biased to move to a second position in which the plunger 402 is no longer engaged by the lever arm 404. The movement of the lever arm 404 away from the plunger 402 is dependent, in part, on the curvature of the portion of the lamp 50 that engages the lever arm 404. The switch 400 may have an internal spring (not in view in figures) or other bias means for extending the plunger 402 when a lamp 50 is removed from the socket 114 and the lever arm 404 is biased away from the plunger 402.

FIGS. 5A and 5B depict an exemplary switch 500 that may be employed in a lamp fixture assembly 100, 312 or 314 in accordance with the present invention. The switch 500 includes a plunger 502 disposed at one end 504 of the switch 500. When the switch 500 is employed in the lamp fixture assembly 100, 312, or 314, the plunger 502 is disposed relative to the lamp fixture 102. In this implementation, when a lamp 50 is inserted into the lamp fixture 102, the lamp 50 engages the plunger 502 moving it to a first position as shown in FIG. 5A to activate the switch 500. As the lamp 50 is removed from the lamp fixture 102, the plunger 502 is biased to move to a second position as shown in FIG. 5B. In one embodiment, the reset switch 500 may be incorporated in the lampholder 114 so that a lamp 50 engages the actuator 504 when the lamp 50 is seated into the lampholder 114.

In this implementation, when the lamp 50 is removed from the lamp fixture 102, the lamp 50 disengages the plunger 502 to deactivate the switch 500. The switch 500 has an internal spring (not in view in figures) or other bias means for extending the plunger 502 to a second position as shown in FIG. 5B as the lamp 50 is being removed from the lamp fixture 102 and disengaging from the plunger 502. The movement of the plunger 502 is dependent, in part, on the curvature of the portion of the lamp 50 that engages the plunger 502.

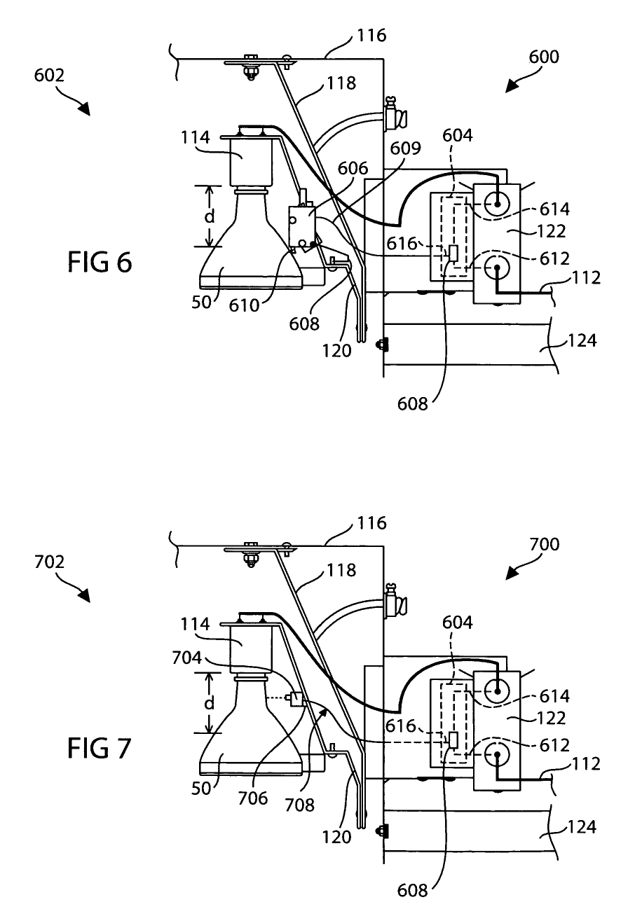

FIG. 6 depicts another exemplary lamp fixture assembly 600 having a lamp fixture 602, an electronic ballast 604, a sensor 606 to detect the installation or the removal of a lamp 50 in the lamp fixture 602, and a reset switch 608 operatively connected to the sensor 606 such that the reset switch 608 resets power to the ballast 604 based on the detected installation or removal of the lamp 50. In the implementation shown in FIG. 6, the sensor 606 is a mechanical switch (e.g., switch 106, 400, or 500) having input 608 connected to ground terminal or, alternatively to a reference voltage (not shown in figures) and an output 609 operatively connected to the reset switch 608. The sensor 606 also has an actuator 610, such as an arm or toggle lever (e.g., actuator 108, 404, or 502), disposed in relation to the lamp fixture 602 such that the sensor 606 detects the removal and the insertion of the lamp 50 into the lamp fixture 602 via the actuator 610. When the sensor 606 detects the removal of the lamp 50, the sensor sends a signal (e.g., open circuit or reference voltage below threshold voltage of the switch 602) via output 609 to deactivate the switch 604 and remove input power for at least a predetermined time period from the branch circuit line 112 to upstream components of the electronic ballast 604 or the lamp fixture 602. When the sensor 606 detects the insertion of the lamp 50, the sensor sends another signal (e.g., ground or reference voltage above threshold voltage of the switch 602) via output 609 to activate the switch 604 and reapply input power from the branch circuit line 112 to upstream components of the electronic ballast 604 or the lamp fixture 602.

The reset switch 608 is solid state power reset switch, such as a power FET switch, that is incorporated into the electronic ballast 604. The reset switch 608 has an input 612 (e.g., power FET source input), an output 614 (e.g., power FET drain output), and a gate 616 that functions as the power input for the electronic ballast 604. The input 612 of the reset switch 608 is operatively connected to a power source, such as the branch circuit line 112. The output 612 of the reset switch 608 is operatively connected to upstream components of the ballast 604 or to the lamp fixture 602. The gate 616 is operatively connected to the output 609 of the sensor 606, such that the gate 616 turns power off and on to the reset switch 608 based on the detected removal and insertion of the lamp 50.

FIG. 7 depicts another exemplary lamp fixture assembly 700 having a lamp fixture 702, an electronic ballast 604, a sensor 704 to detect the installation or the removal of a lamp 50 in the lamp fixture 702, and a reset switch 608 operatively connected to an output 708 of the sensor 706 such that the reset switch 608 resets power to the ballast 604 based on the detected installation or removal of the lamp 50. In the implementation shown in FIG. 7, the sensor 704 is an optical sensor, such as an infrared detector, mounted to the lamp fixture 702 via a bracket 706 so that a lamp 50 inserted into the lamp fixture 702 reflects a beam emitted by the optical sensor 704 back to the optical sensor 704. When the optical sensor 704 does not detect the reflected beam or the removal of the lamp 50, the optical sensor 704 sends a signal (e.g., reference voltage below the threshold voltage of the switch 602) via output 708 to deactivate the switch 604 and remove input power for a predetermined time period from the branch circuit line 112 to upstream components of the electronic ballast 604 or the lamp fixture 702. When the sensor 704 detects the reflected beam or the insertion of the lamp 50, the sensor 704 sends another signal (e.g., reference voltage above the threshold voltage of the switch 602) via output 708 to activate the switch 604 and reapply input power from the branch circuit line 112 to upstream components of the electronic ballast 604 or the lamp fixture 702.

In the implementation shown in FIG. 7, the reset switch 608 is a solid state power reset switch. However, the reset switch 608 employed in the lamp fixture assembly 700 may be a mechanical reset switch external to the electronic ballast 604, where the mechanical reset switch has an electronically driven activation input operatively connected to the output 708 of the sensor 704.

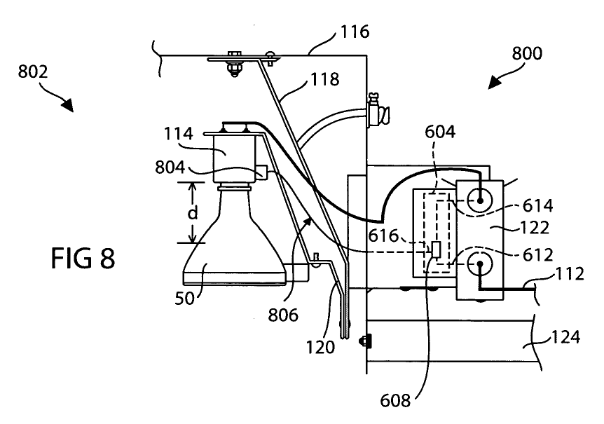

FIG. 8 depicts another exemplary lamp fixture assembly 800 having a lamp fixture 802, an electronic ballast 604, a sensor 804 to detect the installation or the removal of a lamp 50 in the lamp fixture 802, and a reset switch 608 operatively connected to an output 806 of the sensor 804 such that the reset switch 608 resets power to the ballast 604 based on the detected installation or removal of the lamp 50. In the implementation shown in FIG. 8, the sensor 704 is a motion detector sensor, such as a mercury switch detector, mounted to the lampholder 114. In this implementation, the sensor 704 is operatively configured to detect the removal of the lamp when the lampholder is tilted or moved, for example, in a direction away from the bottom 808 of the lampholder 114 for a predetermined distance (e.g., 1-5 mm). The sensor 704 is further operatively configured to detect the insertion of the lamp when the lampholder is tilted or moved, for example, in a direction towards the bottom 808 of the lampholder 114 for the predetermined distance (e.g., 1-5 mm). When the sensor 804 detects the removal of the lamp 50, the sensor 804 sends a signal (e.g., reference voltage below the threshold voltage of the switch 602) via output 806 to deactivate the switch 604 and remove input power for a predetermined time period from the branch circuit line 112 to upstream components of the electronic ballast 604 or the lamp fixture 802. When the sensor 804 detects the insertion of the lamp 50, the sensor 704 sends another signal (e.g., reference voltage above the threshold voltage of the switch 602) via output 806 to activate the switch 604 and reapply input power from the branch circuit line 112 to upstream components of the electronic ballast 604 or the lamp fixture 602.

In the implementation shown in FIG. 8, the reset switch 608 is a solid state power reset switch. However, the reset switch 608 employed in the lamp fixture assembly 800 may be a mechanical reset switch external to the electronic ballast 604, where the mechanical reset switch has an electronically driven activation input operatively connected to the output 708 of the sensor 804.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A lamp fixture assembly, comprising:
a lamp fixture;
a ballast having a power input; and
a reset switch operatively connected between the power input of the ballast and a power source, wherein
the reset switch is disposed in relation to the lamp fixture such that the reset switch is activated to cycle power to the ballast by removal of a lamp from and insertion of the lamp into the lamp fixture.

2. A lamp fixture assembly as set forth in claim 1, wherein the switch has an actuator disposed in relation to the lamp fixture such that a lamp inserted into the lamp fixture engages the actuator.

3. A lamp fixture assembly as set forth in claim 2, wherein the actuator is operatively configured to activate the switch when the actuator is moved to a first position by the insertion of the lamp into the lamp fixture.

4. A lamp fixture assembly as set forth in claim 2, wherein the actuator is operatively configured to deactivate the switch when the lamp is disengaged from the actuator.

5. A lamp fixture assembly as set forth in claim 2, wherein the actuator is operatively configured to deactivate the switch when the actuator is moved to a second position by the removal of the lamp from the lamp fixture.

6. A lamp fixture assembly as set forth in claim 2, wherein the lamp fixture has a socket and the actuator is disposed in relation to the socket.

7. A lamp fixture assembly as set forth in claim 6, wherein the actuator is disposed a predetermined distance away from the socket based on a predetermined size of the lamp.

8. A lamp fixture assembly as set forth in claim 1, wherein the switch comprises a plunger and a lever arm disposed relative to the plunger and relative to the lamp fixture such that the lever arm engages the plunger to activate the switch when the lamp is inserted into the lamp fixture.

9. A lamp fixture assembly as set forth in claim 1, wherein the reset switch is operatively configured to turn off power to the ballast for at least a predetermined time during the removal of the lamp from the lamp fixture.

10. A lamp fixture assembly as set forth in claim 1, wherein the reset switch comprises an optical sensor disposed in relation to the lamp fixture such that the optical sensor detects the removal and the insertion of the lamp, and a power reset switch operatively connected to the optical sensor and the power input of the ballast such that the power reset switch is activated to turn power off to the ballast when the removal of the lamp is detected and to turn power on to the ballast when the insertion of the lamp is detected.

11. A lamp fixture assembly as set forth in claim 1, wherein the reset switch comprises a motion detector disposed in relation to the lamp fixture such that the motion detector detects the removal and the insertion of the lamp, and a power reset switch operatively connected to the motion detector and the power input of the ballast such that the power reset switch is activated to turn power off to the ballast when the removal of the lamp is detected and to turn power on to the ballast when the insertion of the lamp is detected.

12. A lamp fixture assembly, comprising:
a lamp fixture;
a ballast having a power input; and
a power reset switch operatively connected between the power input of the ballast and a power source; and
a sensor disposed in relation to the lamp fixture to detect the removal of a lamp from and the insertion of the lamp into the lamp fixture, and operatively connected to the power reset switch such that the power reset switch removes power from the ballast during the removal of the lamp and reapplies power to the ballast during the insertion of the lamp.

13. A lamp fixture assembly as set forth in claim 12, wherein the power reset switch is incorporated into the ballast.

14. A lamp fixture assembly as set forth in claim 12, wherein the sensor comprises a switch having an actuator disposed in relation to the lamp fixture such that a lamp inserted into the lamp fixture engages the actuator.

15. A lamp fixture assembly as set forth in claim 12, wherein the sensor is an optical sensor.

16. A lamp fixture assembly as set forth in claim 12, wherein the sensor is a motion detector.
